(19) United States
(12) Patent Application Publication
(10) Pub. No.: US 2014/0144595 A1
(43) Pub. Date: May 29, 2014

(54) Multi Functional Window Covering System Using A Single Curtain Rod

(71) Applicant: Lisa Nicole Collins, Marietta, GA (US)

(72) Inventor: Lisa Nicole Collins, Marietta, GA (US)

(21) Appl. No.: 13/868,542

(22) Filed: Apr. 23, 2013

Related U.S. Application Data
(60) Provisional application No. 61/642,492, filed on May 4, 2012.

(51) Int. Cl. E06B 9/24; A47H 23/04

(52) U.S. Cl. CPC E06B 9/24; A47H 23/04
USPC 160/87

(57) ABSTRACT

The multi-functional window covering system consists of a pair of coverings, each covering including a curtain panel and a sheer panel connected along a vertical curtain/sheer interface. There would also be a rod receiving means on a top portion of each covering, and a curtain rod engaged with said rod receiving means. The system allows one to have curtains completely closed; curtains partially closed with sheers open, closed or partially open; or curtains totally open, with sheers open, closed or partially open. The multi-functional window covering system allows the benefit of having both a curtain and a sheer, but only requiring one rod. It also allows the user to control the amount of light and privacy and influence the overall look of the window covering.

### BACKGROUND OF THE INVENTION

The present invention relates to window coverings, and more specifically, to a window covering system that includes a covering having combined curtain and sheer panels, and a single curtain rod.

Curtains are an integral part of many homes because they provide both functional and aesthetic properties. For example, they provide privacy, block out light, and give a room a “finished look.” Sheers are also functional and yet attractive insofar as they filter light, provide some privacy, and are pleasing to the eye. Indeed it is very common for a window covering to include both a curtain and a sheer. This allows one to have curtains completely closed; curtains partially closed with sheers open, closed or partially open; or curtains totally open, with sheers open, closed or partially open. In this manner a user can control the amount of light and privacy, and influence the overall look.

Having both a curtain and a sheer, however, is problematic. For one, it requires two curtain rods, so as to allow the independent sliding movement of each. Two separate curtain rods, or combination dual rods, adds to the cost, complexity and may detract from the aesthetic by providing a “cluttered” look. Another shortcoming of having both a curtain and a sheer on separate rods is that a large portion of the outer portion of the sheer is unnecessary insofar as it is always concealed behind the curtain, thereby wasting material. Also, there can be bunching and otherwise uneven and unattractive draping that results from having two layers of fabric hanging in close proximity, thereby detracting from the aesthetics of the window covering.

As can be seen, there is a need for a multi-functional window covering system using a single curtain rod. It is desirable that this system allows a user's window to be substantially fully exposed, partially exposed, or completely covered. Moreover, it is desirable that the partially exposed window have sheers or no sheers. This system should require only one curtain rod, and be relatively inexpensive with respect to materials and production.

### BRIEF DESCRIPTION OF THE DRAWINGS

FIG. 1 depicts an embodiment of the invention with the curtain panel and sheer portion covering the window; and

FIG. 2 depicts an embodiment of the invention with the curtain portion closed and the sheer portion concealed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-functional window covering system that includes a pair of curtain panels separated by a pair of sheer panels, with each curtain panel connected along its inner vertical edge to a sheer panel.

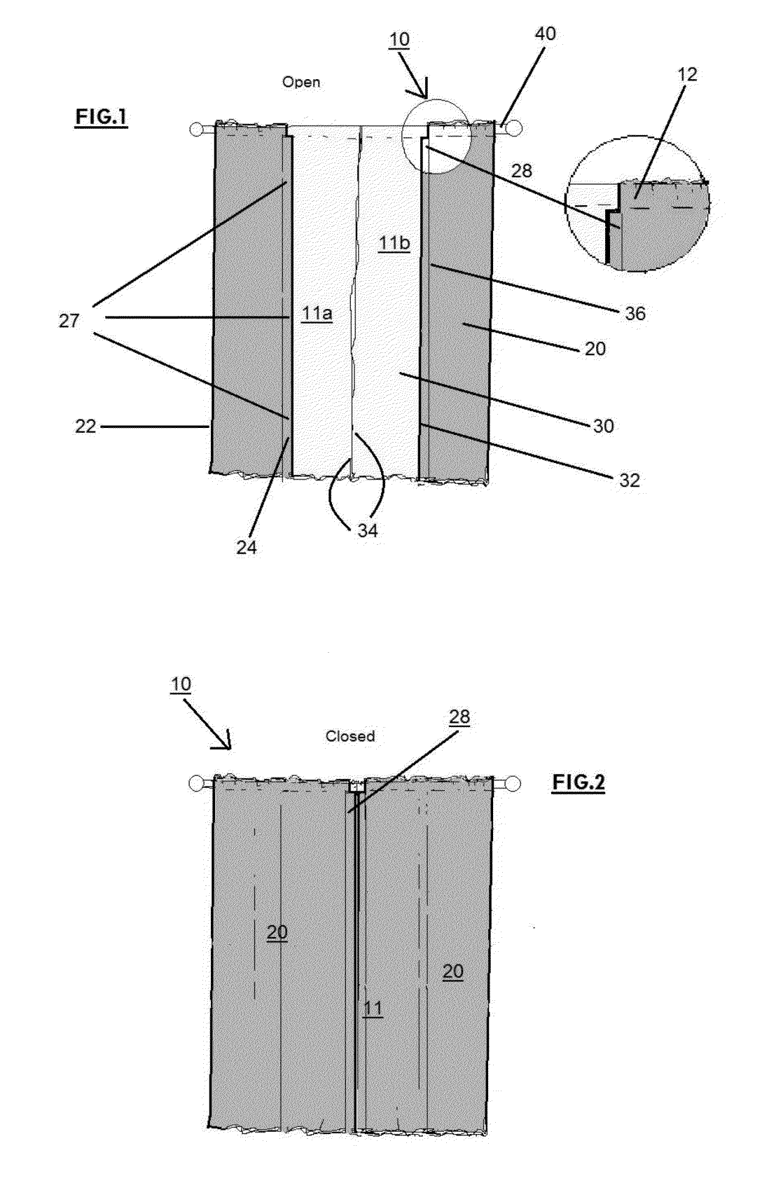

Referring to FIG. 1, window covering system 10 includes covering 11 and curtain rod 40. As is known in the art, covering 11 includes rod receiving means 12, which could be a rod-receiving horizontal pocket open on both ends, curtain tabs, curtain rings, or the like, which slidably secure covering 11 to curtain rod 40. Covering 11 includes two sides, 11a and 11b, which are more-or-less mirror images except for the fastening device 27 and flap 28, discussed below.

Each panel 11 includes curtain panel 20 and sheer panel 30. As used herein, curtain panel 20 generally refers to a window covering that blocks light, whereas sheer panel 30 permits filtered light. Curtain panel 20 and sheer panel 30 are joined along curtain panel inner edge 24 and sheer panel outer edge 32, thereby forming curtain/sheer interface 36. It is desirable that said joining is achieved by a sewn seam. Sheer panel inner edges 34 are preferably finished, thereby providing an aesthetically pleasing look when sheers are exposed, as shown in FIG. 1.

Fastening device 27 (shown on covering 11a in FIG. 1) or flap 28 (shown on covering 11b in FIG. 1) are connected along curtain panel inner edges 24. It should be understood that fastening device 27 may include conventional fastening systems such as snaps, hook/loop strips, buttons, magnets, hooks and the like, and thus there may be mating parts on both covering 11a and 11b. These features allow system 10 to be closed, and fastening device 27 to be concealed by flap 28, as shown in FIG. 2. It should also be understood that sheer panels 30 are concealed behind curtain panels 20 in FIG. 2. When system 10 is closed and fastened, the overall effect is that simply of curtains, without sheers undesirably peeking out or bunching. This orientation remains, even if the window is open and wind is blowing.

It is desirable that covering 11 is constructed of two full-sized curtain panels for the specific window, but what equates to only one half of a sheer panel. By way of example, for a 30×60″ window with 200% fullness covering, covering 11 could be constructed of two 34×64″ curtain panels 20, and two 17×32″ sheer panels 30. Thus, system 10 saves approximately 17×32″ of sheer panel material, versus full sized sheer panels which would conventionally be used in a dual rod system.

In use, one installs curtain rod 40 and coverings 11 in the conventional manner over a window. If maximum light and minimum privacy is desired, coverings 11 are slid along curtain rod 40 to expose the underlying window. If a medium amount of light and privacy are desired, coverings 11 are adjusted so sheer panel inner edges 34 come together, as shown in FIG. 1. If minimum light and maximum privacy is desired, curtain panel inner edges 24 are brought together, fastening device 27 is engaged, and flap 28 is positioned over fastening device 27. It should be understood that other positions are possible as well, depending on the light, privacy and aesthetics desired.

It should be understood, of course, that the foregoing relates to exemplary embodiments of the invention and that modifications may be made without departing from the spirit and scope of the invention as set forth in the following claims. It should also be understood that ranges of values set forth inherently include those values, as well as all increments between.

What is claimed is:

1. A window covering system including:
a. A pair of coverings, each covering including a curtain panel and a sheer panel connected along a vertical curtain/sheer interface;
b. A rod receiving means on a top portion of each covering; and
c. A curtain rod engaged with said rod receiving means.
